(19) United States
(12) Patent Application Publication
(10) Pub. No.: US 2017/0365114 A1
(43) Pub. Date: Dec. 21, 2017

(54) INTEGRATED CARD READER

(71) Applicant: Rockwood Manufacturing Company, Rockwood, PA (US)

(72) Inventors: Luis Bettencourt, New Haven, CT (US); Michael Swearman, New Haven, CT (US); Michael Connell, New Haven, CT (US); Vinny Baker, New Haven, CT (US); Catelyn Herman, New Haven, CT (US); Paul Smith, New Haven, CT (US); Doug Thompson, New Haven, CT (US)

(21) Appl. No.: 15/625,610

(22) Filed: Jun. 16, 2017

Related U.S. Application Data
(60) Provisional application No. 62/351,364, filed on Jun. 17, 2016.

(51) Int. Cl. G07C 9/00; E05B 47/00; E05B 1/00; E06B 3/36; E06B 3/02

(52) U.S. Cl. CPC G07C 9/00111; E06B 3/362; E06B 3/02; E05B 1/0015; E05B 47/0001; E05B 47/0046

(57) ABSTRACT

A door entry system for operating a door using a wireless transmitter device containing identification credentials of a user. The system includes a door operable by an uncoupling or releasing securing mechanism, a door controller capable of operating the uncoupling or releasing securing mechanism and a door handle for grasping by the user to operate the door, the handle having a cavity, the handle being secured to the door and spaced away from a surface thereof. The system includes a wireless device reader disposed in the handle cavity and a power source connected to the card reader. The wireless transmitter may be presented in the vicinity of the reader in the door handle and, upon verification of the credentials transmitted from the wireless transmitter device, the reader sends a signal to the door controller to uncouple or release the securing mechanism and permit the door to open.

### BACKGROUND OF THE INVENTION

### 1. Field of the Invention

The present invention relates to door entry handles which include an integrated card reader.

### 2. Description of Related Art

Conventional readers for RFID card or other wireless signal transmitting devices used to authenticate a user's entry are mounted on a wall adjacent a door or on the surface of the door itself. Such mountings present difficulties for particular types of doors, for example, glass doors, which necessitates the mounting of additional hardware on the glass surface.

### SUMMARY OF THE INVENTION

Accordingly, there is a need for a simplified and effective mounting of a reader for RFID card or other wireless signal transmitting devices on doors, particularly glass doors.

Bearing in mind the problems and deficiencies of the prior art, it is therefore an object of the present invention to provide a system for allowing access through a glass door using a wireless identification key and receiver, the receiver located within a door handle pull on the door.

It is another object of the present invention to provide a wireless identification receiver within a door pull or handle of a door.

A further object of the invention is to provide a system for allowing access through a glass door using a wireless identification key and receiver, including a circuit located in the handle of the door capable of receiving an identification code from a key a user and transmitting a signal to a door locking mechanism.

It is yet another object of the present invention to provide a door or building access system or a method of using the door or building access system which allows a user wireless access through a glass door with the transmitter/receiver circuit located on or within the door handle secured to the glass pane of the door.

It is still another object of the present invention to provide door or building access which allows a user wireless access through a glass door without the wireless access circuit being visible on or within the glass panes of the door.

It is another object of the present invention to provide door or building access which allows a user wireless access through a set of glass door having side glass panes without the wireless access circuit being visible on or within the glass panes of the door or glass side panels.

Still other objects and advantages of the invention will in part be obvious and will in part be apparent from the specification.

The above and other objects, which will be apparent to those skilled in the art, are achieved in the present invention which is directed to a door entry system for operating a door using a wireless transmitter device containing identification credentials of a user. The system includes a door operable by an uncoupling or releasing securing mechanism, a door controller capable of operating the uncoupling or releasing securing mechanism and a door handle for grasping by the user to operate the door, the handle having a cavity, the handle being secured to the door and spaced away from a surface thereof. The system includes a wireless device reader disposed in the handle cavity and a power source connected to the card reader. The wireless transmitter may be presented in the vicinity of the reader in the door handle and, upon verification of the credentials transmitted from the wireless transmitter device, the reader sends a signal to the door controller to uncouple or release the securing mechanism and permit the door to open. The door may be a glass door. The door entry system may include a second door operable by a manual securing system. The door entry system may include a second door having a second securing mechanism operable by the door controller. The glass door may include a rail at the top or bottom of the door, the rail having a latching device with a retractable latchbolt extending therefrom into a strike disposed in the door frame or floor adjacent latching device, the door operable by a latch mechanism which retracts the latchbolt in response to a command from the wireless card reader. The glass door may include a rail at the top or bottom of the door, the rail having a latching device with a retractable latchbolt extending therefrom into a strike disposed in the door frame or floor adjacent latching device, the door operable by an electric strike mechanism which opens the strike in response to a command received at a strike controller from the card reader. The door handle may be an elongated cylindrical handle. The power source may be a battery or a rechargeable battery and charging system. The charging system may include a solar cell or induction charger.

Another aspect of the invention is directed to a door pull comprising an elongated handle having a cavity and a handle portion securable to a door, a wireless card reader disposed in the handle cavity and a power source electronically connected to the card reader. The card reader may be in communication with a door controller, the door controller capable of securing or releasing the glass door to or from a locked position. The wireless card reader may receive an authentication signal from an authorized wireless transmitting device to transmit an authorization signal to a door controller allowing the door to be released from a locked state. The door pull may include a wireless antenna disposed in the handle cavity and the power source may be disposed in the handle cavity, the power source wired to power the card reader and antenna, wherein the wireless card reader receives a signal from an authorized card and the antenna relays an authorization signal to an access control which releases the glass door from a locked state.

Another aspect of the invention is directed to a method for operating a door using a wireless transmitter. The method includes providing a door operable by a releasing securing mechanism, a door controller capable of operating the releasing securing mechanism and a door handle for grasping by a user to operate the door, the handle having a cavity, the handle being secured to the door and spaced away from a surface thereof. The method includes providing a reader disposed in the handle cavity and a power supply connected to the card reader and a wireless transmitting device capable of communication with the reader. The method includes presenting the wireless transmitter device in the vicinity of the reader in the door handle and wirelessly transmitting credentials from the wireless transmitting device. The method includes upon verification of the credentials transmitted from the wireless transmitting device, sending a signal from the reader to the door controller to uncouple or release the securing mechanism and permitting the door to open. The door controller and securing mechanism may be disposed on a top or bottom rail of the door and the card reader may be capable of sending a signal to the door controller to allow the door controller to activate or deactivate the securing mechanism. The door controller and securing mechanism may be disposed in the door a door frame encompassing the door with a strike disposed in a rail disposed on the door. The card reader may be capable of sending a signal to the door controller to allow the door controller to activate or deactivate the securing mechanism. The device reader may be a wireless RFID reader. The door may be a glass door allowing building access and the entry system may allow a user wireless access through the glass door without the wireless access circuit being visible on or within the glass panes of the door. The door may be a pair of glass doors with a stationary glass pane on at least one side of the pair of glass doors whereby the entry system allows a user wireless access through the glass doors without the wireless access circuit being visible on or within the at least one stationary glass pane.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a perspective view of a pair of glass doors having an embodiment of the door entry handle with an integrated card reader of the present invention.

FIG. 2 is a close-up perspective view, partially cut away, of a door entry handle with integrated card reader of FIG. 1.

FIG. 3 is a cross-sectional view of the door entry handle showing the integrated card reader of FIG. 1.

FIG. 4 is a cross-sectional view of a latching mechanism that may be employed on the glass door of FIG. 1 with the integrated card reader of the present invention.

FIG. 5 is a perspective view of an embodiment of a battery pack at the end of a door entry handle that may power the integrated card reader of the present invention.

### DESCRIPTION OF THE PREFERRED EMBODIMENT(S)

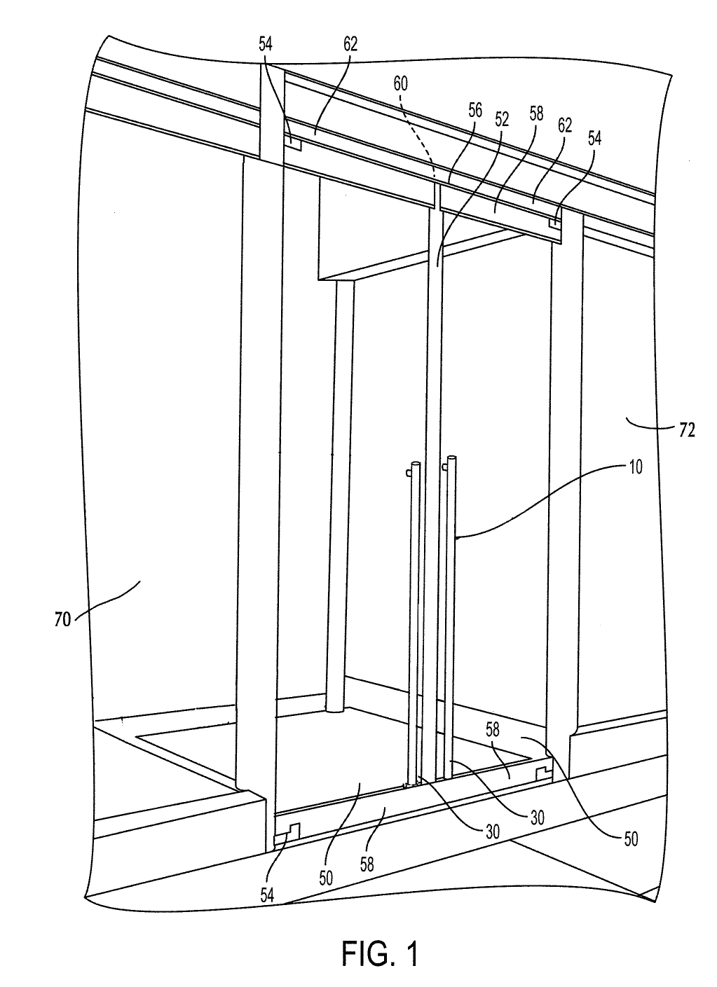

In describing the preferred embodiment of the present invention, reference will be made herein to FIGS. 1-5 of the drawings in which like numerals refer to like features of the invention.

The present invention allows controlled access into a building or enclosed area while minimally impacting the appearance and structure of the entrance door. An embodiment of the invention is employed in an all glass entranceway or other entryway where aesthetics are important and would be highly valued by architects. Access through the door would be given to a user having a proper RFID card or other wireless signal transmitting device in their possession.

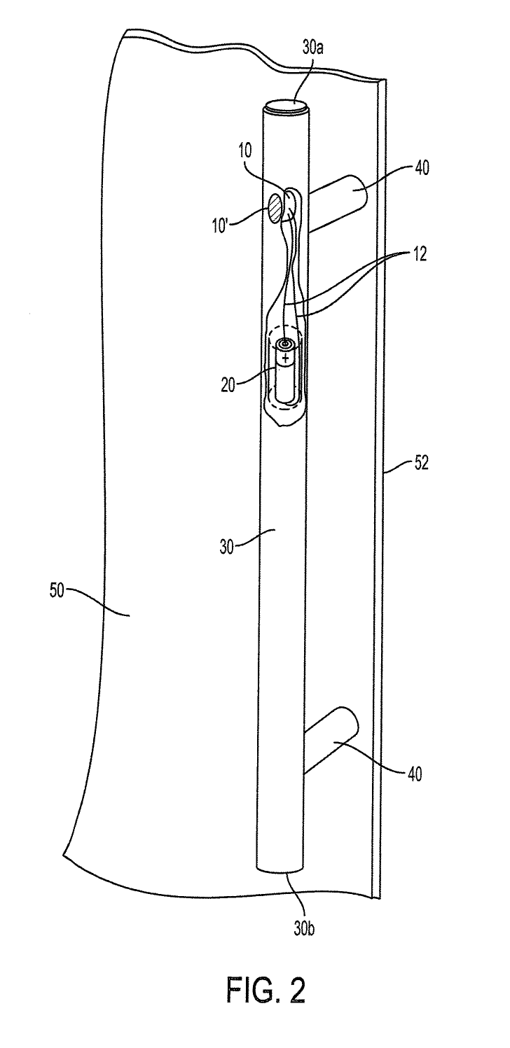

The reader for the RFID or other wireless reader device may be integrated into the handle or pull used to open and close the door. In the embodiment shown in FIGS. 1 and 2, an all glass entryway comprises glass walls or glass side panes 70, 72 within which are mounted glass doors 50, 50′. In one example, one door 50 may include the wireless door entry system while the other door 50′ is operable by a manual securing system, or the doors 50, 50′ may both be operable by a door controller in communication with the wireless reader device. An elongated door pull or other type of handle includes a hollow tube main body 30, an integrated, battery powered wireless reader 10 and a handle connector portion 40 secured to the exterior of glass door 50 adjacent swinging free edge 52. The door handle or pull as shown in the cutaway view of FIG. 2 may be a hollow cylindrical or other shape tube 30 with end caps 30a, 30b secured to the hollow tube. The handle connector portion 40 may be perpendicular to the tube or handle 30 to secure to the face of the door 40 and space the handle from the surface of door 50 a distance sufficient to enable users to wrap their hands around and grasp the tube 30. The wireless reader 10 as shown may be disposed inside the hollow handle at a mid-point between upper and lower ends 30a, 30b and includes a bezel which may be secured, e.g., by snapping in a compression fit, so that face 10′ is disposed on the surface of the hollow tube 30. The face 10′ in the embodiment shown is of cylindrical configuration to match the tube 30. The face 10′ configuration may be shaped to conform to the exterior of other tube configurations, e.g., oval, or flat for rectangular or square. Alternatively, the wireless reader 10 may be disposed in the edge of the top end 30a of the door pull 30 if door pull end is located at a convenient height for users, making it less visible in the door pull. The wireless reader assembly 10, 10′, and 20 may also be constructed in a one piece design to be located on the top end of the handle. Placement of the card reader 10 inside the hollow tube eliminates the visibility of a separate card reader in an all glass entryway, such as that shown in FIG. 1. For longer door pulls where the top of the pull is not easily accessible, the reader may be disposed in a central or lower portion of the pull and wired to a top edge that may secure the battery 20. The door pull may alternately include a rechargeable battery including a charging system such as a solar cell or induction charger.

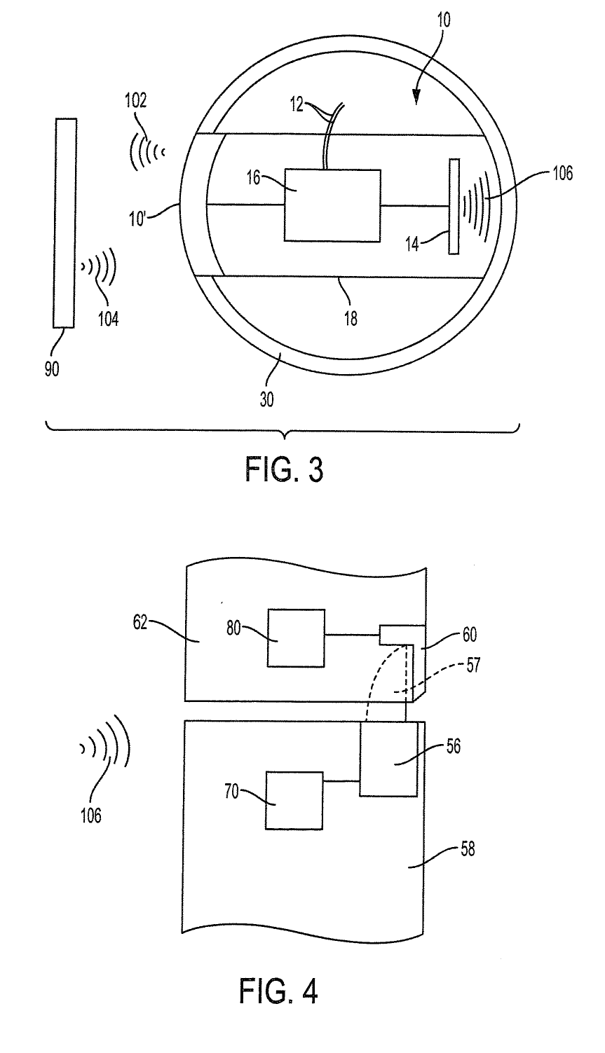

The wireless RFID or other device reader is shown disposed entirely within tubular handle 30 in FIG. 3. The reader 10 includes within housing 18 controller circuitry 16 in communication with an RFID transmitter/receiver located in face 10′, and a transmitting antenna 14 for Wi-Fi or other radio signal. In the case of a passive RFID card or other device 90, transmitter/receiver 10′ sends an inductive interrogator signal 102, which then causes an authentication reply signal 104 to be emitted from RFID device 90. Controller 16 determines whether signal 104 is from an authorized device, in which case it may cause signal 106 to be transmitted to a door controller or other device.

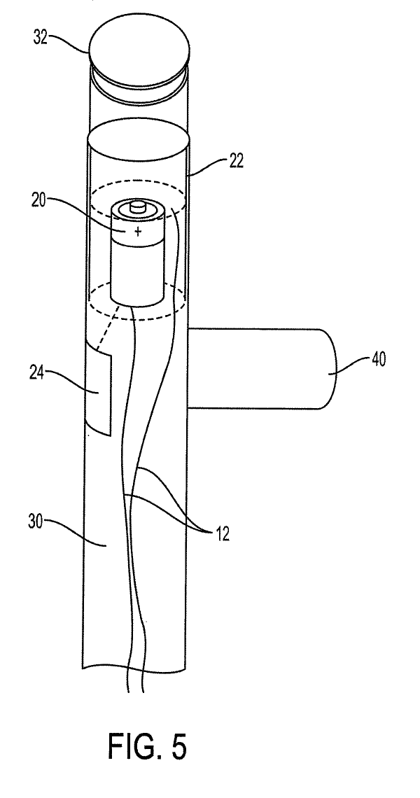

A plurality of conductors 12 electrically connect the battery 20 to the card reader 10. As shown in FIG. 5, battery 20 may be located inside a battery pack 22 that is configured with an end cap 32 of tube 30. Alternately, a solar charger 24 located on a surface of handle 30 may charge a rechargeable battery to power the card reader 10, so less maintenance would be required.

Door 50 as shown includes a wirelessly controlled door latching system, as shown in FIG. 4, which provides an uncoupling/releasing securing mechanism. Door 50 includes a sill or rail 58, at the top or bottom of the door, having a latching device 56 with a retractable latchbolt 57 extending therefrom into strike 60, located in the door frame 62 or floor adjacent latching device 56. The door may be unlocked either by use of a latch mechanism 56 which retracts latchbolt 57 in response to a command from latch controller 70 or an electric strike mechanism 60 which opens the strike in response to a command from strike controller 80.

In use, users would place their unique RFID card or other wireless signal transmitting device 90 near the card reader face 10′ where it may be powered by an inductive signal from the reader 10 to emit proper credentials from the antenna in the form of a signal 104. Alternately, the unique device 90 may be self-powered to send out a signal 104, or may not need power to relay the card code signal to the reader 10. This signal 104 from device 90 would be sent to a Wi-Fi or other wireless hub which is tied into the access control system, disposed in or otherwise in communication with latch controller 70 and/or strike controller 80. The access control system determines if the signal is one that is permitted access to that opening. If access is granted, the access control system unlocks the door securing mechanisms (strike 60 or latching device 56) allowing the user to enter.

A method for using the system may include presenting the wireless transmitter device 90 in the vicinity of the reader 10 in the door handle and wirelessly transmitting credentials from the wireless transmitting device. Upon verification of the credentials transmitted from the wireless transmitting device 90, a signal is sent from the reader 10 to the door controller or latching device 56 to uncouple or release the securing mechanism, permitting the door to open. The door controller and securing mechanism may be disposed on a top or bottom rail of the door and the card reader is capable of sending a signal to the door controller to allow the door controller to activate or deactivate the securing mechanism. Alternately, the door controller and securing mechanism may be disposed in the door a door frame encompassing the door with a strike disposed in the rail on the door and the card reader sends the signal to the door controller to allow the door controller to activate or deactivate the securing mechanism.

Thus, the present invention provides a system for allowing access through a glass door using a wireless identification key and receiver, the receiver located within a door handle pull on the door and a wireless identification receiver within a door pull or handle of a door. The present invention also provides a system for allowing access through a glass door using a wireless identification key and receiver, including a circuit located in the handle of the door capable of receiving an identification code from a key a user and transmitting a signal to a door locking mechanism. The present invention also provides a door or building access system and a method of using the door or building access system which allows a user wireless access through a glass door with the transmitter/receiver circuit located on or within the door handle secured to the glass pane of the door so the wireless access circuit is not visible on or within the glass panes of the door. The present invention also provides the wireless access circuit not being visible on or within glass side panels of the doors.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A door entry system for operating a door using a wireless transmitter device containing identification credentials of a user comprising:
a door operable by an uncoupling or releasing securing mechanism;
a door controller capable of operating the uncoupling or releasing securing mechanism;
a door handle for grasping by the user to operate the door, the handle having a cavity, the handle being secured to the door and spaced away from a surface thereof;
a wireless device reader disposed in the handle cavity; and
a power source connected to the card reader,
wherein the wireless transmitter may be presented in the vicinity of the reader in the door handle and, upon verification of the credentials transmitted from the wireless transmitter device, the reader sends a signal to the door controller to uncouple or release the securing mechanism and permit the door to open.

2. The door entry system of claim 1 wherein the door is a glass door.

3. The door entry system of claim 2 including a second door operable by a manual securing system.

4. The door entry system of claim 2 including a second door having a second securing mechanism operable by the door controller.

5. The door entry system of claim 1 wherein the glass door includes a rail at the top or bottom of the door, the rail having a latching device with a retractable latchbolt extending therefrom into a strike disposed in the door frame or floor adjacent latching device, the door operable by a latch mechanism which retracts the latchbolt in response to a command from the wireless card reader.

6. The door entry system of claim 1 wherein the glass door includes a rail at the top or bottom of the door, the rail having a latching device with a retractable latchbolt extending therefrom into a strike disposed in the door frame or floor adjacent latching device, the door operable by an electric strike mechanism which opens the strike in response to a command received at a strike controller from the card reader.

7. The door entry system of claim 1 wherein the door handle is an elongated cylindrical handle.

8. The door entry system of claim 1 wherein the power source is a battery.

9. The door entry system of claim 1 wherein the power source includes a rechargeable battery and a charging system.

10. The door entry system of claim 9 wherein the charging system includes a solar cell or induction charger.

11. A door pull comprising:
an elongated handle having a cavity and a handle portion securable to a door;
a wireless card reader disposed in the handle cavity; and
a power source electronically connected to the card reader.

12. The door pull of claim 11 wherein the card reader is in communication with a door controller, the door controller capable of securing or releasing the glass door to or from a locked position.

13. The door pull of claim 11 wherein the wireless card reader receives an authentication signal from an authorized wireless transmitting device to transmit an authorization signal to a door controller allowing the door to be released from a locked state.

14. The door pull of claim 11 including a wireless antenna disposed in the handle cavity and the power source disposed in the handle cavity, the power source wired to power the card reader and antenna, wherein the wireless card reader receives a signal from an authorized card and the antenna relays an authorization signal to an access control which releases the glass door from a locked state.

15. A method for operating a door using a wireless transmitter comprising:
providing a door operable by a releasing securing mechanism, a door controller capable of operating the releasing securing mechanism and a door handle for grasping by a user to operate the door, the handle having a cavity, the handle being secured to the door and spaced away from a surface thereof;
providing a reader disposed in the handle cavity and a power supply connected to the card reader;
providing a wireless transmitting device capable of communication with the reader;
presenting the wireless transmitter device in the vicinity of the reader in the door handle;
wirelessly transmitting credentials from the wireless transmitting device;
upon verification of the credentials transmitted from the wireless transmitting device, sending a signal from the reader to the door controller to uncouple or release the securing mechanism; and
permitting the door to open.

16. The method of claim 15 wherein the door controller and securing mechanism are disposed on a top or bottom rail of the door and the card reader is capable of sending a signal to the door controller to allow the door controller to activate or deactivate the securing mechanism.

17. The method of claim 15 wherein the door controller and securing mechanism are disposed in the door a door frame encompassing the door and a strike is disposed in a rail disposed on the door and the card reader is capable of sending a signal to the door controller to allow the door controller to activate or deactivate the securing mechanism.

18. The method of claim 15 the device reader is a wireless RFID reader.

19. The method of claim 15 wherein the door is a glass door allowing building access and the entry system allows a user wireless access through the glass door without the wireless access circuit being visible on or within the glass panes of the door.

20. The method of claim 15 wherein the door is a pair of glass doors with a stationary glass pane on at least one side of the pair of glass doors and the entry system allows a user wireless access through the glass doors without the wireless access circuit being visible on or within the at least one stationary glass pane.
